(19) United States
(12) Patent Application Publication
(10) Pub. No.: US 2015/0277466 A1
(43) Pub. Date: Oct. 1, 2015

(54) DATA PROCESSING APPARATUS, METHOD FOR CONTROLLING THE SAME AND STORAGE MEDIUM

(71) Applicant: CANON KABUSHIKI KAISHA, Tokyo (JP)

(72) Inventor: So Yokomizo, Tokyo (JP)

(21) Appl. No.: 14/663,953

(22) Filed: Mar. 20, 2015

(30) Foreign Application Priority Data
Mar. 27, 2014 (JP) 2014-066804

(51) Int. Cl. G05F 1/66; G05B 15/02

(52) U.S. Cl. CPC G05F 1/66; G05B 15/02

(57) ABSTRACT

A technique for reducing the number of times of power state transition by appropriately executing, at an accelerated time point, processing of an event that needs to be performed in a current power state before transition to another power state is provided. A data processing apparatus according to one aspect of the present invention determines, when transition of a power state from a current power state occurs, whether or not there is an event that is to be scheduled to be performed within a predetermined time in the same power state, and executes the scheduled event at an accelerated time point if it is scheduled to be processed within the predetermined time in the same power state.

### BACKGROUND OF THE INVENTION

1. Field of the Invention

The present invention relates to a data processing apparatus, a method for controlling the same, and a storage medium.

2. Description of the Related Art

In the technical field of data processing apparatuses such as a printing apparatus and a copying apparatus, a demand for reducing power consumption in the state in which the apparatuses do not operate (non-operating state) is growing. In answer to such a demand, a power saving mode is known in which, when the data processing apparatus is in the non-operating state, power supply to a main controller for controlling the data processing apparatus is reduced (or blocked) more than usual, and thereby power consumption in the non-operating state is reduced.

In such control in the power saving mode, when conditions for transition to the power saving mode are satisfied for example, a list of events that will occur within a predetermined time from this point of time and that serve as factors of returning from the power saving mode is acquired. Then, if this list includes return factor events that are scheduled to be executed within the predetermined time, these events may be executed at an accelerated time point. In order to execute such power saving control, it is necessary to not only precisely control powering on/off of devices of the data processing apparatus but also perform the control such that the number of times of powering on/off of the devices is reduced since there may be the case that the reliable number of times of powering on/off is restricted.

In the technique disclosed in Japanese Patent Laid-Open No. 2009-151537, such events are executed at an accelerated time point irrespective of the types of the events, and thus events that do not essentially need to be executed at an accelerated time point, such as an event that should be ensured to be executed at a specific time or an event that should be ensured to be executed at a predetermined time interval, are executed as well. As a result, the event that has been executed at an accelerated time point is to be executed again at the scheduled time, resulting in an increase in the number of times of transition from the power saving mode to the normal power mode, causing the problems that the number of times of powering on/off increase, and the communication load increases, for example.

### SUMMARY OF THE INVENTION

The present invention to solve the problem of the above-described conventional technique provides a technique for reducing the number of times of power state transition by executing, at the time of transition of a power state, an event that is to be performed within a predetermined time in the current power state at an accelerated time point, and prolonging a time period until this event is to be performed next.

According to one aspect of the present invention, there is provided a data processing apparatus comprising: a first determination unit configured to determine, when transition of a power state from a current power state occurs, whether or not there is an event that is scheduled to be performed within a predetermined time in the current power state; a second determination unit configured to determine, if the first determination unit has determined that there is an event that is scheduled to be performed, whether or not processing of the event is able to be performed at an accelerated time point; a performing unit configured to perform, at an accelerated time point, the processing of the event that is determined to be able to be performed at an accelerated time point by the second determination unit; a change unit configured to change a time at which the event is scheduled to be performed in response to the performing unit performing the event; and a control unit configured to perform control such that the power state transitions after the processing of the event is performed by the performing unit.

According to another aspect of the present invention, there is provided a control method of a data processing apparatus comprising: determining, when transition of a power state from a current power state occurs, whether or not there is an event that is scheduled to be performed within a predetermined time in the current power state; determining, if it is determined in the first determination step that there is an event that is scheduled to be performed, whether or not processing of the event is able to be performed at an accelerated time point; performing, at an accelerated time point, the processing of the event that is determined to be able to be performed at an accelerated time point; changing a time at which the event is scheduled to be performed in response to the event being performed in the performing step; and performing control such that the power state transitions after the processing of the event is performed in the performing step.

According to still another aspect of the present invention, there is provided a non-transitory computer-readable storage medium storing a computer program for causing a computer to execute steps of a control method of a data processing apparatus comprising: determining, when transition of a power state from a current power state occurs, whether or not there is an event that is scheduled to be performed within a predetermined time in the current power state; determining, if it is determined in the first determination step that there is an event that is scheduled to be performed, whether or not processing of the event is able to be performed at an accelerated time point; performing, at an accelerated time point, the processing of the event that is determined to be able to be performed at an accelerated time point; changing a time at which the event is scheduled to be performed in response to the event being performed in the performing step; and performing control such that the power state transitions after the processing of the event is performed in the performing step.

According to the present invention, it is possible to reduce the number of times of power state transition by executing, at the time of transition of a power state, an event that is to be performed within a predetermined time in a current power state at an accelerated time point, and prolonging a time period until this event is to be performed next. Furthermore, by reducing the number of times of power state transition, it is possible to improve the power saving efficiency.

Further features of the present invention will become apparent from the following description of exemplary embodiments (with reference to the attached drawings).

### BRIEF DESCRIPTION OF THE DRAWINGS

FIG. 1 is a block diagram illustrating a configuration of an image forming apparatus according to embodiments of the present invention.

FIG. 2 is a block diagram illustrating a hardware configuration of a controller of the image forming apparatus according to the embodiments.

FIG. 3 is a block diagram showing an example of a hardware configuration with regard to power source control of the controller according to the embodiments.

FIG. 4 is a diagram schematically showing a power supply situation of the controller of the image forming apparatus according to the embodiments.

FIG. 5 is a diagram illustrating power state transition of the image forming apparatus according to the embodiments.

FIGS. 6A and 6B are diagrams illustrating examples of events that are processed periodically in Embodiments 1 and 2.

FIG. 7 is a flowchart illustrating power control processing in the image forming apparatus according to Embodiment 1.

FIG. 8 is a flowchart illustrating power control processing in the image forming apparatus according to Embodiment 2.

### DESCRIPTION OF THE EMBODIMENTS

Hereinafter, embodiments of the present invention will be described in detail with reference to the accompanying drawings. Note that the embodiments below are not to restrict the present invention according to the claims, and all of the combinations of features illustrated in the present embodiments are not necessarily essential for solution means of the present invention. The embodiments will describe an image forming apparatus that is an example of a data processing apparatus according to the present invention.

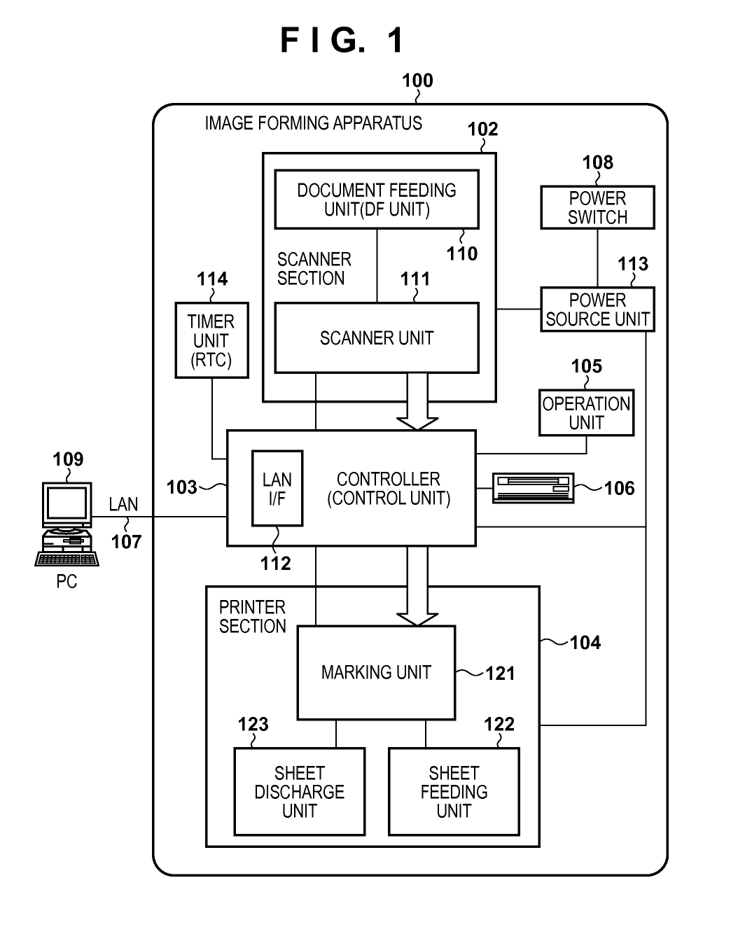

FIG. 1 is a block diagram illustrating a configuration of an image forming apparatus 100 according to embodiments of the present invention. Note that this image forming apparatus 100 is connected to a PC 109, which is a host computer, via a network (LAN) 107. Furthermore, this image forming apparatus 100 is described as being a multifunction peripheral that has a print function, scanner function, box function and the like, but the present invention is not limited to this.

A controller (control unit) 103 is connected to a scanner section 102, a printer section 104, an operation unit 105, an auxiliary storage unit 106, a timer unit (RTC) 114, and the LAN 107, and controls operation of these components. The scanner section 102 optically reads an image of a document, converts the read image into a digital image, and outputs the converted digital image. The printer section 104 prints an image on a sheet (recording medium) such as paper based on image data. The operation unit 105 configures a user interface, and the user operates this operation unit 105 to instruct the operation and the like of the image forming apparatus 100. The auxiliary storage unit 106 is a storage unit such as a hard disk drive (HDD) and stores digital images, control programs, and the like. This image forming apparatus 100 can also perform input/output of digital image data in/from the computer 109 via the LAN 107, reception of a job, and the like. The power source unit 113 is connected to a power switch 108 for turning on/off the connection to a commercial power source, and controls power supply to the scanner section 102, the controller 103, and the printer section 104. The timer unit (RTC) 114 clocks a time, and has the function to notify the controller 103 of a predetermined time using an interruption or the like upon clocking the predetermined time, in accordance with an instruction of the controller 103. A network interface (LAN I/F) 112 controls an interface to the LAN 107.

The scanner section 102 includes a document feeding unit 110 on which a bundle of documents is placed and that conveys the documents one by one to a scanner unit 111, and the scanner unit 111 that optically scans a document and converts the scanned document into digital image data. Image data obtained by the scanner section 102 reading a document is transmitted from the scanner section 102 to the controller 103. The printer section 104 includes a sheet feeding unit 122 that feeds sheets one by one from the bundle of sheets to a marking unit 121, the marking unit 121 that performs printing on the fed sheets, and a sheet discharge unit 123 that discharges printed sheets.

An operation unit 105 includes operating buttons for use by a user to instruct the image forming apparatus 100 to perform operation such as copying of an image, and a display panel such as liquid crystal for use for presenting various types of information on the image forming apparatus 100 to a user, the operating buttons and the display panel (not shown). Note that this display panel may also include a touch panel.

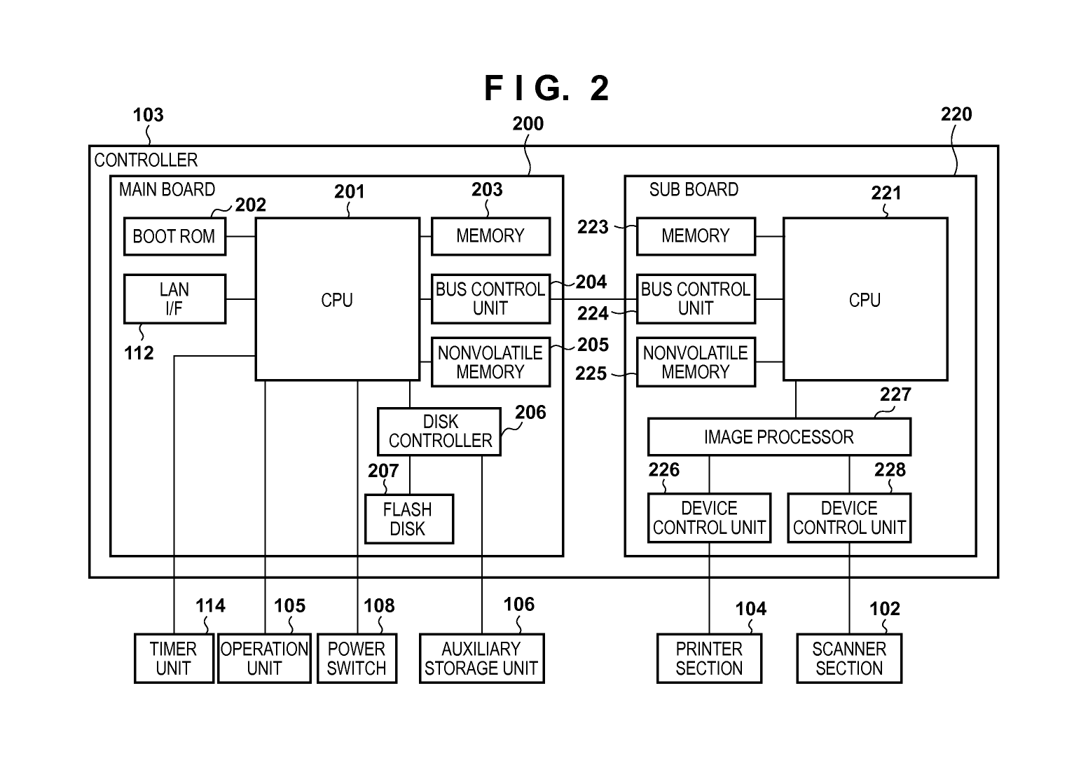

FIG. 2 is a block diagram illustrating a hardware configuration of the controller 103 of the image forming apparatus 100 according to the embodiments.

This controller 103 is provided with a main board (main controller) 200 and a sub board 220. The main board 200 is a substrate on which a general-purpose CPU system is installed. The main board 200 includes a CPU 201 that performs overall control, a boot ROM 202 that stores therein a boot program, a memory 203 that is used as a work memory by the CPU 201, a bus control unit 204 having the bridge function to an external bus, and a nonvolatile memory 205. The main board 200 further includes a disk controller 206 that controls the storage device (auxiliary storage unit 106), and a flash disk 207 (such as an SSD), which is a storage device that has a relatively small capacity and is configured by a semiconductor device. Furthermore, the operation unit 105, the power switch 108, the timer unit 114, and the like are connected to the main board 200.

The sub board 220 includes a relatively small general-purpose CPU system and hardware for image processing. The sub board 220 includes a CPU 221, a memory 223 that is used as a work memory by the CPU 221, a bus control unit 224 having the bridge function to an external bus, and a nonvolatile memory 225. The sub board 220 further includes an image processor 227 that performs image processing on a real-time basis, and device control units 226 and 228. The scanner section 102 and the printer section 104 transmit and receive digital image data to and from the sub board 220 via the device control units 228 and 226, respectively. Note that FIG. 2 is a block diagram and thus simplified. For example, large amounts of CPU peripheral hardware such as a chip set, a bus bridge, and a clock generator, are included in the CPU 201, the CPU 221, and the like, but are omitted since they are not essential components of the present invention, and the configuration of this block diagram does not limit the present invention.

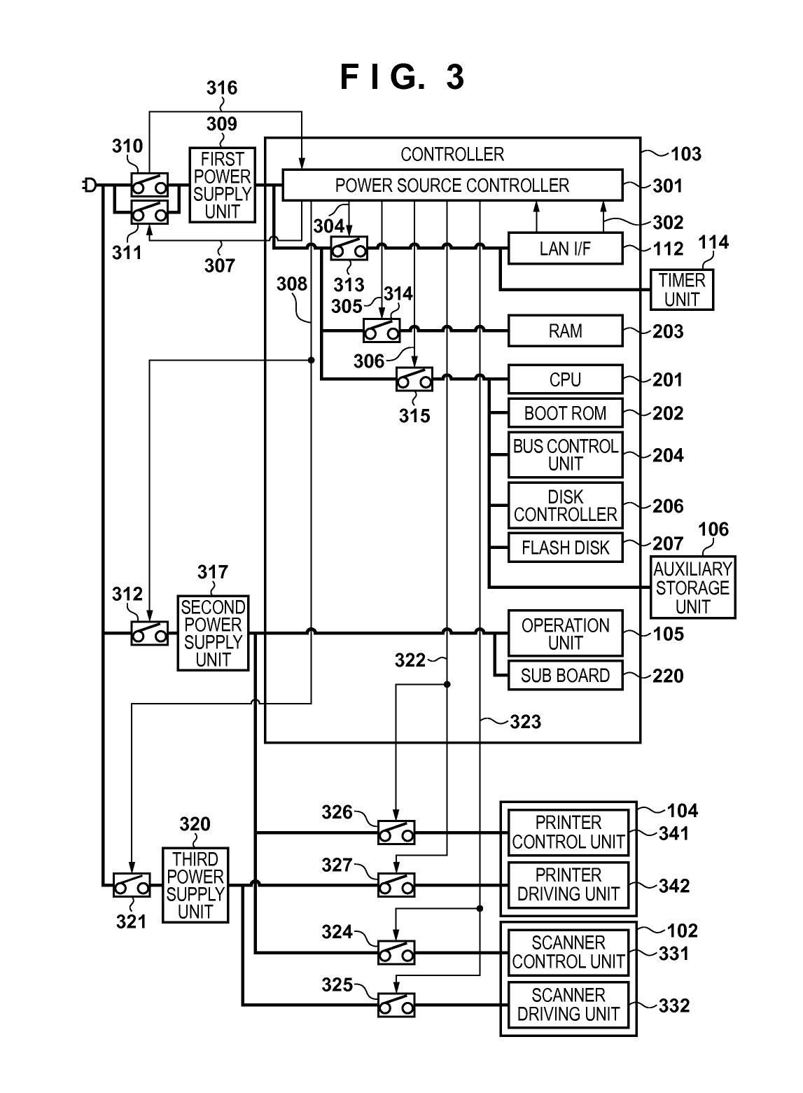

FIG. 3 is a block diagram showing an example of a hardware configuration with regard to power source control of the controller 103 according to the embodiments. The power switch 108 of FIG. 2 corresponds to switches 310 to 315, 321, and 324 to 327 of FIG. 3, and the power source unit 113 of FIG. 1 corresponds to a power source controller 301, a first power supply unit 309, a second power supply unit 317, a third power supply unit 320, and the like of FIG. 3.

Upon receiving a command from the CPU 201 or a return signal (Wake 1 signal 302) for returning from the sleep state from the LAN I/F 112, the power source controller 301 controls whether or not to cause the first power supply unit 309 and the second power supply unit 317 to supply power to the components. The first power supply unit 309 corresponds to an all-night power source, and supplies power (first power) of 5 V, for example. The second power supply unit 317 and the third power supply unit 320 correspond to non-all-night power sources, and respectively supply power (second power) of 12 V and power (third power) of 24 V, for example. That is, the second power and the third power that are supplied by the second power supply unit 317 and the third power supply unit 320 are powers that correspond to voltages that are higher than that of the first power supplied by the first power supply unit 309.

The power source controller 301 controls control signals 304 to 307, and the first power is supplied to the CPU 201, the memory 203, the boot ROM 202, and the auxiliary storage unit 106 from the first power supply unit 309. Also, the first power is supplied to the LAN I/F 112, the timer unit 114, and the power source controller 301 itself from the first power supply unit 309.

Furthermore, the power source controller 301 controls the control signal 308 to perform supply control of AC power to the second power supply unit 317 and the third power supply unit 320. Accordingly, the power source controller 301 performs control such that the second power supply unit 317 supplies the second power to the operation unit 105 and the sub board 220. Furthermore, the power source controller 301 controls control signals 322 and 323 to perform supply control of the second power and the third power to the printer section 104 and the scanner section 102. Furthermore, the power source controller 301 can control the control signals 304 to 308, 322, and 323 so that the image forming apparatus transitions to the sleep state in which power consumption is restricted. In this sleep state, power supply to the main board 200 is blocked. That is, power supply to the memory 203, the CPU 201, the boot ROM 202, the bus control unit 204, the disk controller 206, the flash disk 207, the auxiliary storage unit 106, the operation unit 105, the sub board 220, the printer section 104, and the scanner section 102 is blocked. Also, the power source controller 301 performs control such that the first power supply unit 309 supplies the first power to the LAN I/F 112 and the power source controller 301 itself.

The Wake 1 signal (first return signal) 302 is a signal that is transmitted by the LAN I/F 112 to notify, when the LAN I/F 112 receives a job packet via the network 107 in the sleep state, the power source controller 301 of that reception. Upon detecting this Wake 1 signal 302, the power source controller 301 controls the control signals 304 to 308 and 322. These control signals 304 to 308, 322 and 323 are signals for controlling whether or not power supply is to be performed on the devices.

Furthermore, the switches 311 to 315, 321, and 324 to 327 are switches that are controlled to be turned on/off by the control signals 304 to 308, 322, and 323. By the power source controller 301 controlling turning on/off of the switches 311 to 315, 321, 324 to 327 using the control signals 304 to 308, 322 and 323, it is possible to change the power supply state with respect to the devices. Note that these switches 311 to 315, 321, and 324 to 327 can be realized by FETs, relay switches, or the like.

The control signal 304 and the switch 313 control power supply to the LAN I/F 112 and the timer unit 114. The control signal 305 and the switch 314 control supply of the first power to the memory 203. The control signal 306 and the switch 315 control supply of the first power to the CPU 201, the boot ROM 202, the bus control unit 204, the disk controller 206, the flash disk 207, and the auxiliary storage unit 106. That is, the switch 315 switches supply and stop of power from the first power supply unit 309 to the CPU 201, the boot ROM 202, and the like. The control signal 307 and the switch 311 control supply of AC power to the first power supply unit 309. The control signal 307 and the switch 311 are turned on by the power source controller 301 when the power switch 310, which will be described later, is turned on. Accordingly, even when a user turns the power switch 310 off, it is possible to supply power to the controller 103. At that time, the power source controller 301 detects that the power switch 310 is turned off with the signal 316 for acquiring information indicating whether the power switch 310 is turned off or on. Also, the power source controller 301 notifies the CPU 201 of the power switch 310 being turned off, and thereby the CPU 201 can perform normal shutdown processing and then block power supply to the devices. This power switch 310 is a switch for use by a user to operate to power on/off this image forming apparatus 100, and it is configured that AC power is supplied to the first power supply unit 309 by the user turning the power switch 310 on.

The control signal 308 and the switch 312 control supply of AC power to the second power supply unit 317. Furthermore, the control signal 308 and the switch 312 control supply of the second power to the devices. The switch 312 is controlled by the power source controller 301 so as to be turned on and off, and switches supply and stop of power from the second power supply unit 317. The control signal 308 and the switch 321 control supply of AC power to the third power supply unit 320.

The first power supply unit 309 converts the AC power into DC power, and supplies the first power to the power source controller 301 and the like. The first power supplied from the first power supply unit 309 is power that is provided for being supplied to the power source controller 301 and the like even when this image forming apparatus 100 transitioned to the power saving state. The second power supply unit 317 converts the AC power into DC power, and supplies the second power to the devices. The third power supply unit 320 converts the AC power into DC power, and supplies the third power to the devices.

The control signal 322 and the switches 326 and 327 control supply of the second and third powers to a printer control unit 341 and a printer driving unit 342. In other words, the control signal 322 and the switches 326 and 327 are provided for controlling the power supply to the printer section 104. For example, with regard to power supply to the printer section 104, in the power saving state, the switches 326 and 327 are turned off and power supply to the printer section 104 is stopped. When the print operation is performed, the switches 326 and 327 are turned on, and power is supplied to the printer section 104 from the second power supply unit 317 and the third power supply unit 320. That is, the switches 326 and 327 are controlled so as to be turned on and off by the power source controller 301, switching supply and stop of power to the printer section 104 from the second power supply unit 317 and the third power supply unit 320.

Furthermore, the control signal 323 and the switches 324 and 325 control supply of the second and third powers to a scanner control unit 331 and a scanner driving unit 332. In other words, the control signal 323 and the switches 324 and 325 are provided for controlling the power supply to the scanner section 102. For example, with regard to power supply to the scanner section 102, in the sleep state, the switches 324 and 325 are turned off, and the power supply to the scanner section 102 is stopped. When the scan operation is performed, the switches 324 and 325 are turned on, and power is supplied to the scanner section 102 from the second power supply unit 317 and the third power supply unit 320. That is, the switches 324 and 325 are controlled so as to be turned on and off by the power source controller 301, switching supply and stop of power to the scanner section 102 from the second power supply unit 317 and the third power supply unit 320.

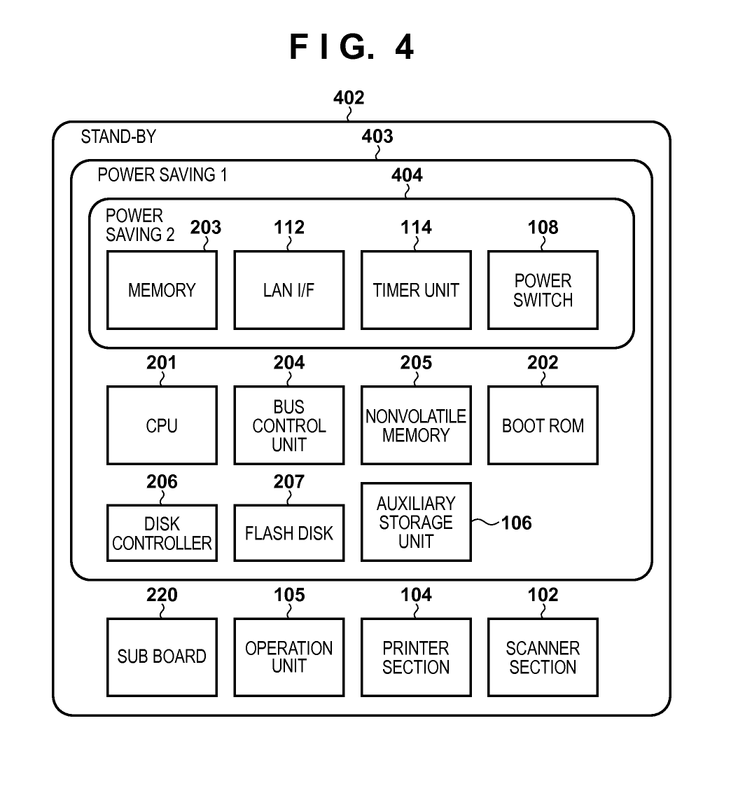

FIG. 4 is a diagram schematically showing the power supply situation of the controller 103 of the image forming apparatus 100 according to the embodiments.

In a stand-by state (402), power is supplied to all blocks included in the controller 103. In this state, the image forming apparatus 100 can perform all the functions.

In a power saving state 1 (403), power is supplied to the main board 200, the timer unit 114, the power switch 108, and the auxiliary storage unit 106, but not to the sub board 220 and the like. In this state, processing performed only by the main board 200, such as processing for notifying a particular server of apparatus settings and registration of the apparatus itself to the network, can be performed. On the other hand, input of image data from the scanner section 102, and printing by the printer section 104 are not possible.

In a power saving state 2 (404), power is supplied to the memory (RAM) 203 and the LAN I/F 112 of the main board 200, the timer unit 114, and the power switch 108, but not to the CPU 201 and the like. In this state, the following processing is performed, that is, reply of a specific protocol by the LAN I/F 112 by proxy, and notification processing for enabling return from the sleep state (power saving mode) when the timer unit 114 clocks a set time.

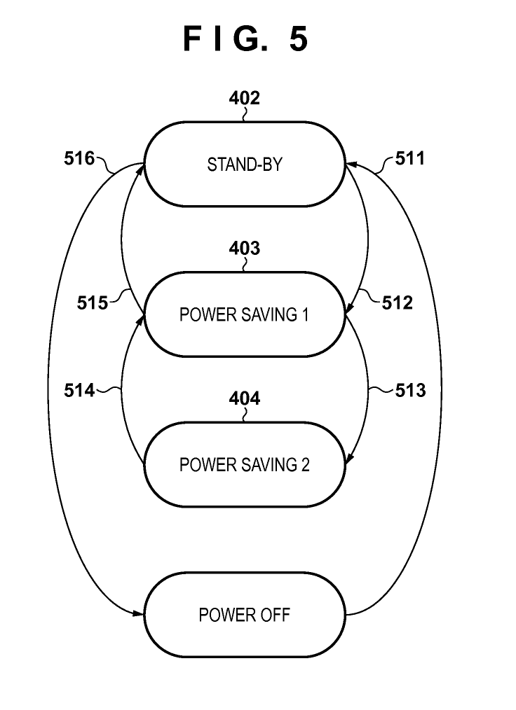

FIG. 5 is a diagram illustrating the power state transition of the image forming apparatus 100 according to the embodiments.

The apparatus in the power off state transitions to the stand-by state (402) by a transition event 511. Examples of the transition event 511 include powering-on by a user, and detection of a designated time clocked by the timer unit 114. The image forming apparatus 100 in the stand-by state (402) transitions to the power saving state 1 (403) by a transition event 512. Examples of this transition event 512 include a user operation for transition to the power saving mode, and the timer unit 114 clocking a predetermined time. Furthermore, when a transition event 513, which will be described later, occurs at the same time, the image forming apparatus 100 in the stand-by state (402) may also transition to the power saving state 2 (404) via the power saving state 1 (403). Furthermore, the image forming apparatus 100 in the stand-by state (402) transitions to the power off state by a transition event 516. Examples of this transition event 516 include powering-off by a user, and the timer unit 114 clocking a predetermined time.

The image forming apparatus 100 in the power saving state 1 (403) transitions to the power saving state 2 (404) by the transition event 513. Examples of this transition event 513 include the timer unit 114 clocking a predetermined time. Furthermore, the image forming apparatus 100 in the power saving state 1 (403) transitions (returns) to the stand-by state (402) by a transition event 515. Examples of this transition event 515 include a user operation for transition to the normal operation mode, the case that data received via the LAN 107 includes a print job that is to be performed using the printer section 104.

The image forming apparatus 100 in the power saving state 2 (404) transitions to the power saving state 1 (404) by a transition event 514. Examples of this transition event 514 include reception of a network packet, a user operation for transition to the power saving mode, and the timer unit 114 clocking a predetermined time. Furthermore, when a transition event 515 occurs at the same time, the image forming apparatus 100 transitions to the stand-by state (402) via the power saving state 1 (403).

The image forming apparatus 100 according to the embodiments thus have the forgoing configuration and operation states.

### Embodiment 1

Hereinafter, Embodiment 1 of the present invention will be described. In Embodiment 1, the image forming apparatus 100, when transitioning to the power saving state 1 from the stand-by state, executes processing of impending events that are executable at an accelerated time point and then transitions to the power saving state 1. Accordingly, it is possible to prevent occurrence of state transition, such as a situation in which the image forming apparatus 100 transitions to the power saving state 1 and immediately then returns to the stand-by state by receiving another event.

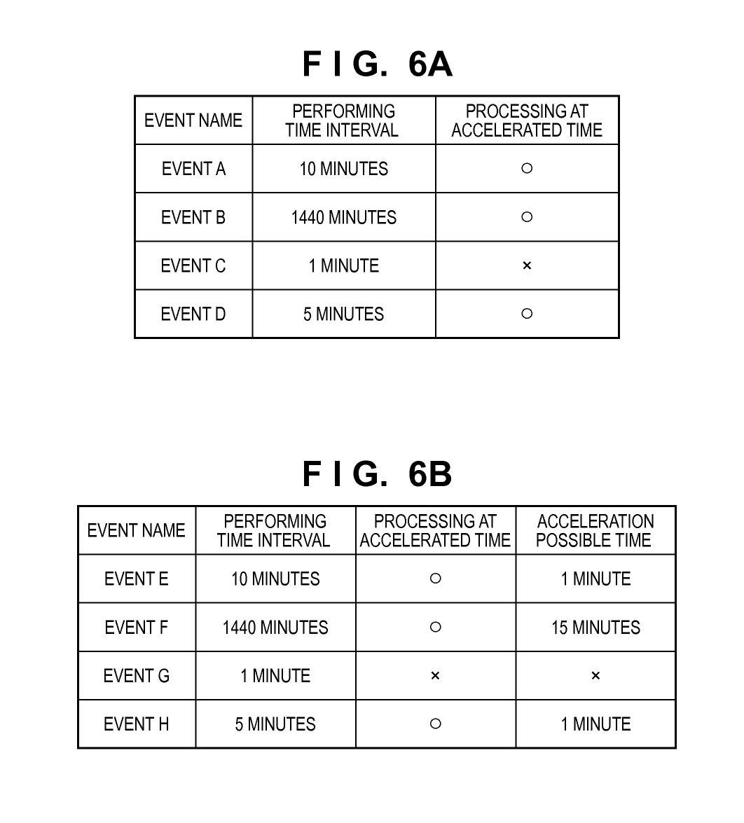

FIG. 6A is a diagram illustrating examples of events that are processed periodically in Embodiment 1. It is assumed here that these events are executed in the power saving state 1 (403), and when the image forming apparatus 100 receives these events while being in the power saving state 2 for example, transition from the power saving state 2 to the power saving state 1 occurs.

An event A is an event that is processed every 10 minutes, and is shown as an event that can be processed at an accelerated time point. Examples of this event include registration processing of a network. Similarly, an event B is an event that is processed every 1440 minutes, that is, every 24 hours, and an event D is an event that is processed every 5 minutes. Each of these events can be processed at an accelerated time point without posing a problem. Note that although it is assumed in Embodiment 1 that a fixed value is uniquely set for an acceleration possible time irrespective of the events, it is also possible that a user arbitrarily configures the setting using the operation unit 105 and the like.

An event C is an event that is processed every 1 minute and cannot be processed at an accelerated time point. Examples of the event C include a device being powered on at a given time every day, and time display in which a value is counted up every one minute and another type of processing is performed when the counted value is a given value.

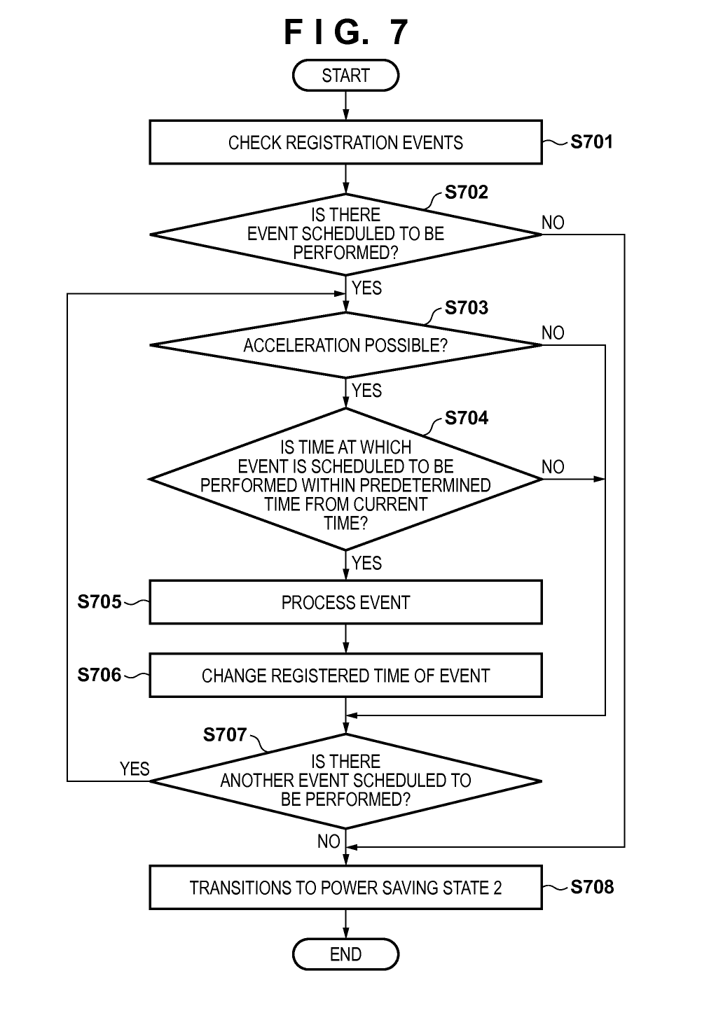

FIG. 7 is a flowchart illustrating power control processing in the image forming apparatus 100, according to Embodiment 1. A program for executing this processing is stored in the auxiliary storage unit 106 or the flash disk 207, read out to the memory 203 at the time of execution, and executed under the control of the CPU 201. Here, the case will be described in which the periodic events shown in FIG. 6A are registered, and are executed at an accelerated time point. It is assumed that the image forming apparatus 100 is in the power saving state 1 (403) at the time of start of this processing, and this processing is started by the occurrence of the transition event 513 for transitioning to the power saving state 2 (404) from the power saving state 1 (403). However, it is also possible that the image forming apparatus 100 is in the stand-by state, and this processing is started by, for example, the occurrence of the transition event 512 for transitioning to the power saving state 1 (403).

In step S701, the CPU 201 checks the registration condition of periodic events registered in this image forming apparatus 100. Then, the procedure advances to step 702, where the CPU 201 determines whether or not there is a periodic event that is scheduled to be performed, and if it is determined that there is such a periodic event, the procedure advances to step S703, whereas if it is determined that there is no such a periodic event, the procedure advances to step S708, where the image forming apparatus 100 transitions to the power saving state 2 (404), and this procedure ends.

In step S703, the CPU 201 checks the periodic events that are scheduled to be performed in order and determines whether or not each periodic event is an event that can be processed at an accelerated time point, and if it is determined that the periodic event is an event that can be processed at an accelerated time point, the procedure advances to step S704, and otherwise to step S707. In step S704, the CPU 201 determines whether or not a time at which this event is scheduled to be performed is within a predetermined time from the current time, and if it is determined that the time is within the predetermined time, the procedure advances to step S705, where the CPU 201 executes processing of this event that can be processed at an accelerated time point. On the other hand, if it is determined that the time is not within the predetermined time, the procedure advances to step S707. Here, the predetermined time is a value that is defined in advance, and if the predetermined time is 1 minute for example, and an event is to be performed at 12:00, the current time will correspond to a time point in the time period from 11:59 to 12:00.

Accordingly, if the CPU 201 executes, in step S705, processing of the event that is executable at an accelerated time point, the procedure advances to step S706, where the CPU 201 changes the time registered for this event to the current time. Accordingly, this event is anew registered so as to be executed periodically from the executed time. This is to prevent this event from being executed again at the time originally scheduled for that event, after the event has been processed at an accelerated time point. Then, the procedure advances to step S707, where the CPU 201 determines whether or not there is another event that is scheduled to be performed, and if it is determined that there is such an event that is scheduled to be performed, the procedure returns to step S703, where the same procedure as that described above is executed. Accordingly, if, in step S707, the CPU 201 determines that there is no other event that is scheduled to be performed, the procedure advances to step S708, where the image forming apparatus 100 transitions to the power saving state 2 (404), and this procedure ends.

As described above, according to Embodiment 1, an event that can be performed at an accelerated time point is set among events that can be performed at a predetermined time interval, and at the time of transition to another power state, the apparatus performs, at an accelerated time point, the event that is scheduled to be performed within the predetermined time, and then transitions to the other power state.

Accordingly, it is possible to eliminate occurrence of the situation that, for example, the image forming apparatus 100 transitions to the power saving state 2 from the power saving state 1, and immediately then transitions to the power saving state 1 in response to an occurrence of an event for returning to the power saving state 1. That is, the number of times of powering on/off of the image forming apparatus can be reduced, and a reduction in the number of times of power state transition brings about the advantage that the power saving efficiency of the image forming apparatus 100 can be improved.

### Embodiment 2

FIG. 6B is a diagram illustrating examples of events that are processed periodically in Embodiment 2. It is assumed here that these events are executed in the power saving state 1 (403), and when the image forming apparatus 100 receives these events while being in the power saving state 2 for example, transition from the power saving state 2 to the power saving state 1 occurs.

An event E is an event that is processed every 10 minutes and can be processed at an accelerated time point, and 1 minute is set for the acceleration possible time. Similarly, an event F is an event that is processed every 1440 minutes, that is, every 24 hours, and 15 minutes is set for the acceleration possible time. An event H is an event that is processed every 5 minutes and can be processed at an accelerated time point, and 1 minute is set for the acceleration possible time. “Acceleration possible time” is calculated as a certain percentage of a time interval (performing time interval) that is a time interval at which an event is performed. For example, assume the case where an event is processed at an accelerated time point if the time difference is within 1% of the performing time interval. When the performing time interval is 10 minutes, 1 minute is set for the acceleration possible time since it is calculated by 10 (minutes)×0.01=0.1 (minute) in which the result is rounded up to the unit of minutes. Similarly, when the performing time interval is 24 hours, 15 minutes is set for the acceleration possible time since it is calculated by 1440 (minutes)×0.01=14.4 (minutes) in which the result is rounded up to the unit of minutes. Note that although it is assumed in Embodiment 2 that a fixed value is set for the rate of the acceleration possible time, it is also possible that a user arbitrarily configures the setting using the operation unit 105 and the like. Furthermore, the rate is 100% at most, and in this case, the event is not fail to be processed at an accelerated time point. Furthermore, the acceleration possible time may also have an upper limit, and the upper limit may be set if the acceleration possible time is a predetermined time or more. Furthermore, examples of events that can be processed at an accelerated time point are as described above.

An event G cannot be executed at an accelerated time point since the performing time interval is 1 minute.

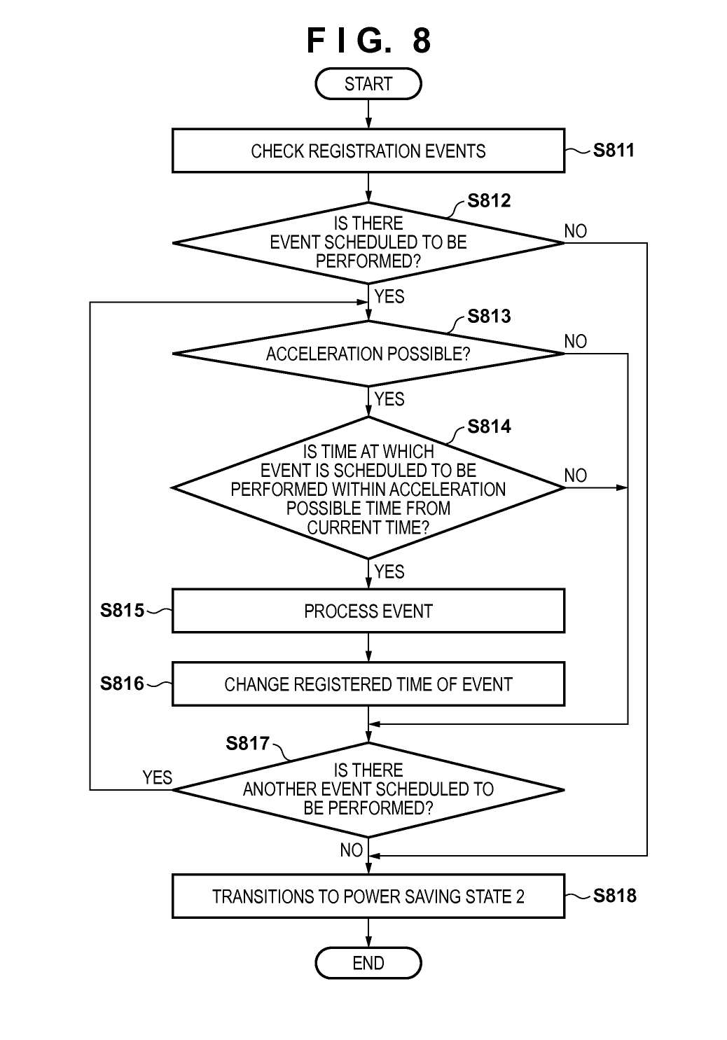

FIG. 8 is a flowchart illustrating power control processing in an image forming apparatus according to Embodiment 2. A program for executing this processing is stored in the auxiliary storage unit 106 or the flash disk 207, read out to the memory 203 at the time of execution, and executed by the CPU 201. Here, the case will be described in which the periodic events shown in FIG. 6B are registered, and are executed at an accelerated time point. It is assumed that the image forming apparatus 100 is in the power saving state 1 (403) at the time of start of this processing, and this processing is started by the transition event 513. However, it is also possible that the image forming apparatus 100 is in the stand-by state, and this processing is started by, for example, the occurrence of the transition event 512 to the power saving state 1 (403).

When the transition event 513 occurs, the CPU 201 checks, in step S811, the registration condition of periodic events registered in the image forming apparatus 100. Then, the procedure advances to step S812, where the CPU 201 determines whether or not there is a periodic event that is scheduled to be performed. If it is determined here that there is such a periodic event, the procedure advances to step S813, whereas if it is determined that there is no such a periodic event, the procedure advances to step S818, where the image forming apparatus 100 transitions to the power saving state 2 (404), and this procedure ends.

In step S813, the CPU 201 checks the periodic events that are scheduled to be performed in order and determines whether or not there is an event that can be performed at an accelerated time point, and if it is determined that there is such an event, the procedure advances to step S814, where it is determined whether or not the time at which this event is scheduled to be performed is within the set acceleration possible time from the current time. Here, if the CPU 201 has determined that the time at which this event is scheduled to be performed is within the set acceleration possible time from the current time, the procedure advances to step S815, where the CPU 201 executes processing of this event that can be processed at an accelerated time point. Note here that the acceleration possible time is a value that is defined for each event at the time of registration of the event as shown, for example, in FIG. 6B. For example, the acceleration possible time for the event E is 1 minute, and thus if this event is to be performed at 12:00 for example, the current time will correspond to a time point in the time period from 11:59 to 12:00, that is, within 1 minute ahead from 12:00. Accordingly, control depending on each event is possible.

Accordingly, after the event is executed in step S815, the procedure advances to step S816, where the CPU 201 updates the time that is registered for this event to the current time. Accordingly, this event is anew performed periodically from the newly registered time of performance. This is to prevent this event from being executed again at the time that is originally scheduled for this event, immediately after this event has been processed at an accelerated time point.

Then, the procedure advances to step S817, where the CPU 201 determines whether or not there is another event that is scheduled to be performed, and if it is determined that there is such an event that is scheduled to be performed, the procedure returns to step S813, where the same procedure as that described above is executed. Accordingly, when, in step S817, there is no other event that is scheduled to be performed, the procedure advances to step S818, where the CPU 201 lets the power state of the image forming apparatus 100 transition to the power saving state 2 (404), and this procedure ends.

As describe above, according to Embodiment 2, an acceleration possible time is registered for each of events that can be processed at an accelerated time point, and the event is executed at an accelerated time point if the scheduled time is within the acceleration possible time. Accordingly, in contrast to Embodiment 1, it is possible to set an acceleration possible time suitably for each event, making it possible to effectively process the event at an accelerated time point. This can lead to a reduction in the number of times of powering on/off of the apparatus, and a reduction in the number of times of power state transition can improve the power saving efficiency. Note that although here a predetermined percentage of the performing time interval is set for an acceleration possible time for an event, the present invention is not limited to this, and the acceleration possible time for an event may also be a predetermined time, or a time having a time width between the minimum time and the maximum time.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-066804, filed Mar. 27, 2014, which is hereby incorporated by reference herein in its entirety.

What is claimed is:

1. A data processing apparatus comprising:
a first determination unit configured to determine, when transition of a power state from a current power state occurs, whether or not there is an event that is scheduled to be performed within a predetermined time in the current power state;
a second determination unit configured to determine, if the first determination unit has determined that there is an event that is scheduled to be performed, whether or not processing of the event is able to be performed at an accelerated time point;
a performing unit configured to perform, at an accelerated time point, the processing of the event that is determined to be able to be performed at an accelerated time point by the second determination unit;
a change unit configured to change a time at which the event is scheduled to be performed in response to the performing unit performing the event; and
a control unit configured to perform control such that the power state transitions after the processing of the event is performed by the performing unit.

2. The data processing apparatus according to claim 1,
wherein the first determination unit is configured to determine whether or not there is the event that is scheduled to be performed within the predetermined time from the time at which transition of the power state occurs, by using, as the predetermined time, a predetermined percentage of a time interval at which the event that is scheduled to be performed is performed.

3. The data processing apparatus according to claim 1, further comprising:
a storage unit configured to store, for each event that is scheduled to be performed, a performing time interval at which the event is performed and information indicating whether or not the event is able to be performed at an accelerated time point.

4. The data processing apparatus according to claim 3,
wherein the change unit is configured to update a performed time of the event with the time at which the event was performed at an accelerated time point, the performed time being used as a basis for the determination by the first determination unit based on the performing time interval stored in the storage unit.

5. The data processing apparatus according to claim 1, further comprising:
a timing unit configured to clock a time.

6. The data processing apparatus according to claim 1,
wherein the power state transitions among a stand-by state in which a normal power is supplied, a first power saving state in which power supply to a main controller that includes at least a CPU is performed, and a second power saving state in which power supply to the CPU is blocked.

7. The data processing apparatus according to claim 5,
wherein the first determination unit is configured to determine whether or not there is an event that is scheduled to be performed within the predetermined time from the time at which transition of the power state occurs and that is clocked by the timing unit.

8. The data processing apparatus according to claim 5,
wherein the first determination unit is configured to determine whether or not there is an event that is scheduled to be performed within the predetermined time from a current time clocked by the timing unit.

9. A control method of a data processing apparatus comprising:
determining, when transition of a power state from a current power state occurs, whether or not there is an event that is scheduled to be performed within a predetermined time in the current power state;
determining, if it is determined in the first determination step that there is an event that is scheduled to be performed, whether or not processing of the event is able to be performed at an accelerated time point;
performing, at an accelerated time point, the processing of the event that is determined to be able to be performed at an accelerated time point;
changing a time at which the event is scheduled to be performed in response to the event being performed in the performing step; and
performing control such that the power state transitions after the processing of the event is performed in the performing step.

10. A non-transitory computer-readable storage medium storing a computer program for causing a computer to execute steps of a control method of a data processing apparatus comprising:
determining, when transition of a power state from a current power state occurs, whether or not there is an event that is scheduled to be performed within a predetermined time in the current power state;
determining, if it is determined in the first determination step that there is an event that is scheduled to be performed, whether or not processing of the event is able to be performed at an accelerated time point;
performing, at an accelerated time point, the processing of the event that is determined to be able to be performed at an accelerated time point;
changing a time at which the event is scheduled to be performed in response to the event being performed in the performing step; and
performing control such that the power state transitions after the processing of the event is performed in the performing step.
